(19) United States
(12) Patent Application Publication
(10) Pub. No.: US 2025/0215577 A1
(43) Pub. Date: Jul. 3, 2025

(54) ELECTROCHEMICAL LITHIUM EXTRACTION AND RECOVERY

(71) Applicant: Wisconsin Alumni Research Foundation, Madison, WI (US)

(72) Inventors: Kyoung-Shin Choi, Fitchburg, WI (US); Dohwan Nam, Madison, WI (US); Brian Foster, Madison, WI (US); Ryan Belson, Madison, WI (US); Princess Cherish Merenini, Madison, WI (US)

(21) Appl. No.: 18/396,865

(22) Filed: Dec. 27, 2023

(51) Int. Cl. C25B 1/14; C22B 3/08; C22B 3/42; C25B 1/02

(52) U.S. Cl. CPC C25B 1/14; C22B 3/08; C22B 3/42; C25B 1/02

(57) ABSTRACT

Methods and systems for the electrochemical extraction and recovery of lithium ions from spent lithium-ion battery electrodes and other lithium sources are provided. The methods and systems use a lithium-storage electrode to remove lithium ions (Li⁺) from an aqueous electrolyte solution in an electrochemical lithium extraction step. In a subsequent electrochemical lithium recovery step, lithium ions stored in the lithium-storage electrode are released into a lithium recovery solution. The lithium may be recovered in various forms, depending upon the design of the electrochemical cells used in the methods and systems. For example, lithium can be recovered as lithium phosphate (Li₃PO₄), lithium hydroxide (LiOH), and/or lithium carbonate (Li₂CO₃).

### BACKGROUND

Given society's push towards incorporating more carbon-free energy sources, the use of electric vehicles (EVs) has increased significantly in the last decade. Most EVs use lithium-ion batteries (LIBs) for power due to the high energy density and high operating voltage of LIBs. LIBs are also used in many other applications including energy storage systems (ESSs) that store electrical energy generated from intermittent renewable sources (solar and wind). Thus, the rapid and continued increase in the use of LIBs for EVs and other applications will result in the generation of a massive amount of spent batteries in the future. To ensure sustainable production of LIBs and minimize the negative environmental impact of discarding spent LIBs, it is critical to develop green and economically viable processes for the treatment of spent LIB batteries and recovery of valuable resources (i.e., Li and other important elements from the electrodes) from them.

Current methods for recovering Li from spent LIBs include pyrometallurgy and hydrometallurgy, which both have their limitations. Pyrometallurgy is energy intensive as it requires high temperatures and pressures, while the recovery yield of Li is low. Hydrometallurgy requires an extensive series of steps that require various chemicals, thus generating considerable waste.

### SUMMARY

Methods and electrochemical cells for the electrochemical extraction and recovery of lithium ions from spent lithium-ion battery electrodes and other lithium sources are provided.

One embodiment of a method for electrochemically extracting and recovering lithium ions from lithium iron phosphate includes the steps of: leaching lithium ions from lithium iron phosphate into an aqueous leachate solution; contacting the aqueous leachate solution with a lithium-storage electrode and carrying out an electrochemical lithium ion extraction from the aqueous leachate solution using the lithium-storage electrode, whereby the lithium-storage electrode becomes lithiated; and contacting the lithiated lithium-storage electrode with an aqueous lithium-recovery solution, wherein the lithium-recovery solution is not the same solution as the aqueous leachate solution, and carrying out an electrochemical delithiation of the lithiated lithium-storage electrode, whereby lithium ions from the lithiated lithium-storage electrode are released into the aqueous lithium-recovery solution.

One embodiment of a method for electrochemically extracting and recovering lithium ions from a lithium ion-containing aqueous solution includes the steps of: contacting the lithium ion-containing aqueous solution with a lithium-storage electrode comprising LiTi₂(PO₄)₃, TiP₂O₇, 5,7,12,14 pentacenetetrone, or polyimide and a counter electrode; carrying out an electrochemical lithium ion extraction from the lithium ion-containing aqueous solution using the lithium-storage electrode, whereby the lithium-storage electrode becomes lithiated; carrying out an electrochemical oxidation in the lithium ion-containing aqueous solution simultaneously with the electrochemical lithium ion extraction; and contacting the lithiated lithium-storage electrode with an aqueous lithium-recovery solution, wherein the aqueous lithium-recovery solution is not the same solution as the lithium ion-containing aqueous solution, and carrying out an electrochemical delithiation of the lithiated lithium-storage electrode, whereby lithium ions from the lithiated lithium-storage electrode are released into the aqueous lithium-recovery solution.

In the method for electrochemically extracting and recovering lithium ions from a lithium ion-containing aqueous solution, the lithium ion-containing aqueous solution may further comprise phosphate ions and the lithium ion-containing aqueous solution may be contacted with the lithium-storage electrode and a phosphate-storage electrode. In such embodiment, the methods include the additional step of carrying out an electrochemical phosphate ion extraction from the aqueous leachate solution using the phosphate-storage electrode, whereby the phosphate-storage electrode becomes phosphatated. This method may optionally include the further step of contacting the phosphatated phosphate-storage electrode with the aqueous lithium-recovery solution and carrying out an electrochemical dephosphatation of the phosphate-storage electrode, whereby phosphate ions are released into the aqueous lithium-recovery solution and lithium phosphate is accumulated in the lithium-recovery solution. One example of a suitable phosphate-storage electrode is a bismuth-containing electrode.

The method for electrochemically extracting and recovering lithium ions from a lithium ion-containing aqueous solution may further include the step of carrying out an electrochemical hydrogen evolution reaction simultaneously with the electrochemical delithiation of the lithiated lithium-storage electrode, whereby water molecules in the aqueous lithium-recovery solution are reduced and hydroxide ions are produced, and lithium hydroxide is accumulated in the lithium-recovery solution. Such methods may include the additional step of introducing carbon dioxide, a bicarbonate salt, or a carbonate salt into the lithium-recovery solution to recover lithium as LiHCO₃ or Li₂CO₃ from the lithium-recovery solution.

The method for electrochemically extracting and recovering lithium ions from a lithium ion-containing aqueous solution may further include the step of carrying out an electrochemical oxygen reduction reaction simultaneously with the electrochemical delithiation of the lithiated lithium-storage electrode, whereby oxygen molecules present in the aqueous lithium-recovery solution are reduced to form hydroxide ions and lithium hydroxide is accumulated in the lithium-recovery solution. Such methods may include the additional step of introducing carbon dioxide or a carbonate salt into the lithium-recovery solution to form Li₂CO₃ and recovering the Li₂CO₃ from the lithium-recovery solution.

In the method for electrochemically extracting and recovering lithium ions from a lithium ion-containing aqueous solution, the electrochemical oxidation may be an electrochemical oxygen evolution reaction.

One embodiment of an electrochemical cell includes: a lithium-storage electrode; a counter electrode that is either: a phosphate-storage electrode comprising bismuth or another phosphate-storage material, such as zinc, copper, or iron; or a chloride-storage electrode comprising bismuth or an oxygen evolution electrode comprising bismuth; and an external circuit or wire connecting the lithium-storage electrode to the counter electrode. In the electrochemical cell, the lithium-storage electrode may comprise LiTi₂(PO₄)₃, TiP₂O₇, 5,7,12,14 pentacenetetrone, or polyimide.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A shows the chemical process of leaching lithium ions (Li⁺) from lithium iron phosphate (LiFePO₄) using phosphoric acid (H₃PO₄) and hydrogen peroxide (H₂O₂).

FIG. 1B is a schematic diagram of an electrochemical cell for extracting Li⁺ from the acidic leachate solution from FIG. 1A using a Li-storage electrode as a cathode and a phosphate-storage electrode as an anode.

FIG. 1C is a schematic diagram of an electrochemical cell for lithium recovery using the lithium-storage electrode as an anode and the phosphate-storage electrode as a cathode to recover lithium in the form of lithium phosphate (Li₃PO₄).

FIG. 2A shows the mechanism for continuous LiFePO₄ leaching using phosphoric acid regenerated at a phosphate-storage anode in a lithium-extraction cell. (The reaction equations shown in the figure ignore stoichiometry for simplicity.)

FIG. 2B shows the use of a separate tank for the addition of LiFePO₄ and H₂O₂ with electrolyte circulation between the tank and an electrochemical Li-extraction cell. (The reaction equations shown in the figure ignore stoichiometry for simplicity.)

FIG. 3A shows a Li-recovery electrochemical cell in which a Li-storage anode is coupled with a hydrogen evolution cathode and Lit is recovered as LiOH or Li₂CO₃.

FIG. 3B shows a phosphate-recovery electrochemical cell in which a phosphate-storage cathode is coupled with an oxygen evolution anode and phosphate is recovered as H₃PO₄.

FIG. 4A shows a Li-extraction electrochemical cell in which lithium extraction is coupled with oxygen evolution in an electrolyte solution containing H₂SO₄.

FIG. 4B shows a Li-recovery electrochemical cell in which lithium release is coupled with hydrogen evolution and lithium is recovered as LiOH or Li₂CO₃.

FIG. 5 shows V-t plots of a LiTi₂(PO₄)₃ cathode and a Bi anode vs. Ag/AgCl (4 M KCl) during the operation of a Li-extraction cell at 7.68 mA/cm² in 0.5 M LiH₂PO₄, as described in the Example.

FIG. 6 shows an X-ray diffraction pattern of pure Li₃PO₄ formed in 0.5 M LiCl in the Li-recovery cell after the lithium release and phosphate release reactions.

FIG. 7 shows V-t plots of a Li₃Ti₂(PO₄)₃ anode and a Bi/BiPO₄ cathode vs. Ag/AgCl (4 M KCl) during the operation of a Li-recovery cell at 7.68 mA/cm² in 0.5 M LiCl, as described in the Example.

FIG. 8 shows the cycle performances of the Bi electrode performing phosphatation (in 0.5 M LiH₂PO₄) and dephosphatation (in 0.5 M LiCl) coupled with the LiTi₂(PO₄)₃ electrode performing lithiation (in 0.5 M LiH₂PO₄) and delithiation (in 0.5 M LiCl), as described in the Example.

### DETAILED DESCRIPTION

Methods and systems for the electrochemical extraction and recovery of lithium ions from spent lithium-ion battery electrodes and other lithium sources are provided. The methods and systems use a lithium-storage electrode to remove lithium ions (Li⁺) from an aqueous electrolyte solution in an electrochemical lithium extraction step. In a subsequent electrochemical lithium recovery step, lithium ions stored in the lithium-storage electrode are released into a lithium recovery solution. The electrochemical extraction and recovery methods recover lithium as a high-purity Li-containing chemical with a high yield in an efficient and environmentally benign manner. The lithium may be recovered in various forms, depending upon the design of the electrochemical cells used in the methods and systems. For example, lithium can be recovered as lithium phosphate (Li₃PO₄), lithium hydroxide (LiOH), and/or lithium carbonate (Li₂CO₃).

In some embodiments of the electrochemical methods and systems, the lithium source is lithium iron phosphate (LiFePO₄), which may be obtained, for example, from spent lithium-ion battery electrodes. The ability to recover lithium from LiFePO₄ electrodes is significant, as LiFePO₄ is an inexpensive, relatively non-toxic, and thermally stable cathode material that is widely used in EVs and ESSs.

### Lithium Leaching From LiFePO₄₍ₛ₎

To prepare a solution for lithium extraction and recovery, lithium ions are leached from a solid lithium iron phosphate using an aqueous leachate solution. Known aqueous solution-based lithium leaching methods may be used. Descriptions of illustrative methods may be found, for example, in ACS Sustainable Chem. Eng. 2017, 5, 8017-8024. In some embodiments, the aqueous leachate solution contains an acid and an oxidant. While the acid alone can dissolve Li⁺ in the LiFePO₄₍ₛ₎, it also dissolves Fe²⁺. For this reason, an oxidizing agent is desirably included in the solution to oxidize Fe²⁺ to Fe³⁺ in LiFePO₄ and form Fe₃PO₄₍ₛ₎, which has a low solubility in acidic media, so that only Li⁺ is leached from the LiFePO₄ into the solution. Suitable acids include mineral acids, such as phosphoric acid, sulfuric acid, hydrochloric acid, and nitric acid, or a mixture of two or more thereof, and organic acids, such as acetic acid, citric acid, and oxalic acid. The oxidant may be any oxidant that oxidizes the Fe²⁺ in LiFePO₄ to Fe³⁺. Suitable oxidants include hydrogen peroxide (H₂O₂), sodium persulfate (Na₂S₂O₈), O₂, sodium hypochlorite, or a combination of two or more thereof. The LiFePO₄ may be obtained from spent LIB electrodes or another source. It should be noted, however, that the aqueous leachate solution need not be an acidic solution and, in some embodiments of the lithium leaching, a neutral or a basic solution may be used, provided it is coupled with a chemical or an electrochemical method to leach lithium from LiFePO₄.

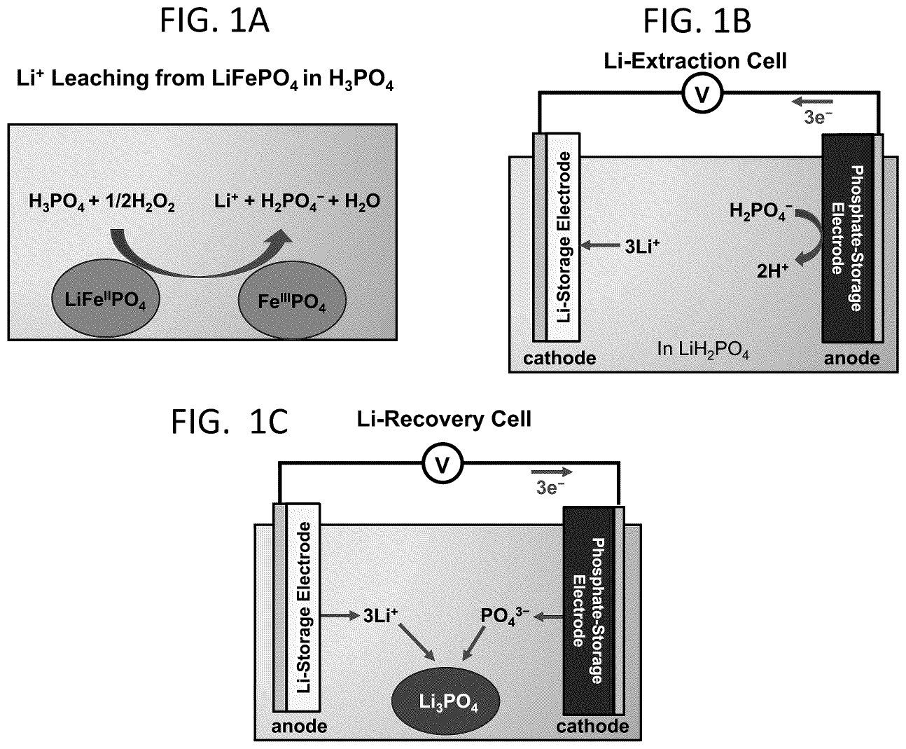

In some embodiments of the methods, phosphoric acid is used as an acid and hydrogen peroxide is used as an oxidant in the leachate solution to produce an electrolyte solution that includes lithium ions and phosphate ions, as illustrated in FIG. 1A, which shows Li⁺ being leached from LiFePO₄ in a phosphoric acid solution according to the following chemical equation:

LiFePO₄(s)+H⁺+1/2H₂O₂→FePO₄(s)+Li⁺(aq)+H₂O (Eq. 1)

(In this case, hydrogen peroxide is used as an illustrative oxidant; an analogous chemical equation can be written for other oxidants.)

The Li⁺-leaching reaction consumes a stoichiometric amount of H⁺ as shown in Eq. 1 (Li⁺:H⁺=1:1), thereby increasing the solution pH. In this solution, H₃PO₄, which is a weak acid, serves as the proton source. Thus, Eq. 1 can be written as Eq. 2.

LiFePO₄(s)+H₃PO₄+1/2H₂O₂→FePO₄(s)+H₂PO₄⁻+Li⁺+H₂O (Eq. 2)

In other embodiments of the methods, sulfuric acid is used as an acid and hydrogen peroxide is used as an oxidant in the leachate solution to provide an electrolyte solution that includes lithium ions and sulfate ions according to the following chemical equation:

2LiFePO₄(s)+H₂SO₄+H₂O₂→2FePO₄(s)+2Li⁺+SO₄²⁻+2H₂O (Eq. 3)

(Here, again, hydrogen peroxide is used as an illustrative oxidant; an analogous chemical equation can be written for other oxidants.)

Once the lithium ions have been leached into the solution, said solution may be used as an electrolyte solution in the electrochemical extraction of lithium ions. Depending, at least in part, on the acid present in the electrolyte solution, the lithium extraction can be paired with various anode reactions in a Li-extraction cell and lithium release can be paired with various cathode reactions in a Li-recovery cell, as illustrated in more detail below.

### Electrochemical Li Extraction Paired With Phosphate Extraction

When phosphoric acid is included in the electrolyte solution, the solution will contain phosphate ions, such as H₂PO₄⁻, HPO₄²⁻, and PO₄³⁻. In some embodiments of the electrochemical Li-extraction cells that use phosphoric acid in the electrolyte solution, the cathode is a lithium-storage electrode, the anode is a phosphate-storage electrode, and Lit and phosphate ions (PO₄³⁻) are electrochemically extracted from the electrolyte solution and stored in the Li-storage electrode (referred to as lithiation) and phosphate-storage electrodes (referred to as phosphatation), respectively, during cell operation.

A schematic diagram of an electrochemical extraction cell that removes lithium ions and phosphate ions from an electrolyte solution is shown in FIG. 1B. The cell includes a lithium-storage electrode and a phosphate-storage electrode connected by an external circuit or wire and a voltage source configured to apply a voltage across the electrodes. The lithium-storage and phosphate-storage electrodes are in contact with (e.g., submerged in) an aqueous electrolyte solution that contains the lithium and phosphate ions. The Li-extraction cell may be run until the cathode and anode are saturated with their respective ions or until a desired level of ion extraction has been achieved.

The electrochemical extraction of lithium from LiFePO₄ electrodes is less cumbersome, less expensive, and more environmentally friendly than lithium recovery from LiFePO₄ electrodes using hydrometallurgical methods. This is because the leachate solutions formed from the leaching of spent LiFePO₄ electrodes typically contain various inorganic or organic species. In hydrometallurgical methods, Li⁺ in the leachate solution is recovered by chemical precipitation. Therefore, all organic or inorganic species in the solution that can co-precipitate with Li⁺ during a Li recovery step must be completely removed; otherwise, the purity of the Li-containing chemicals will be lowered. Each of these species may require different chemicals and procedures, making the entire separation step cumbersome, expensive, and environmentally unfriendly.

In contrast, in the electrochemical Li-extraction cell of FIG. 1B, any impurities present in the leachate solution are not removed from the solution. Rather, the species to be recovered (Li⁺ and phosphate) are selectively extracted from the leachate solution using Li-storage and phosphate-storage electrodes without the need to add additional chemicals. This makes the process simple and more environmentally friendly. And, because the extracted Li⁺ and phosphate can be recovered as Li₃PO₄ in a separate Li recovery cell, as described in more detail below, the Li₃PO₄ can be obtained with a high yield and high purity.

Only Li-storage electrode materials that are stable both in the electrolyte solutions used in the Li-extraction cell and the Li-recovery cell can be used in the electrochemical lithium extraction and recovery methods described herein. The storage of the lithium ions may be by the reversible intercalation of the lithium ions into the crystal structure of the lithium-storage electrode material. The lithium-storage electrode may be of a type that is used in LIBs. However, not all LIB lithium-storage electrode materials are suitable for lithium ion extraction and recovery. Most LIBs use nonaqueous electrolyte solutions and, in some cases, near-neutral aqueous electrolyte solutions. The lithium-storage electrode in a LIB is coupled with another lithium-storage electrode, one performing a lithium-storage reaction and the other performing a lithium-release reaction (and vice versa), so that the composition of the electrolyte solution does not change during the cell operation. Also, the lithium-storage or lithium-release reactions in a LIB do not change the solution pH. Furthermore, the electrolyte solution in a LIB is present in a sealed cell, meaning the lithium-storage and lithium-release reactions occur in the same electrolyte solution that is optimized for these reactions. The lithium-storage electrodes used in LIBs can operate stably under these conditions. However, the Li-extraction and Li-recovery cells described herein use different aqueous electrolyte solutions during lithium ion extraction and lithium ion recovery. The different electrolyte solutions may have various pH conditions that are chosen to optimize the Li-extraction or the Li-recovery processes. The electrolyte solutions used in lithium ion extraction and recovery may also contain anions that are not present in LIB electrolyte solutions (e.g., phosphate). Furthermore, the counter electrode reactions used in the Li-extraction and Li-recovery electrochemical cells do not correspond to the lithium storage and release reactions of a LIB and, in the Li-extraction and Li-recovery cells described herein, the reactions at the counter electrode increase or decrease solution pH. Therefore, many Li-storage electrodes that are used for LIBs are not stable for use in the Li-extraction and Li-recovery cells. For example, LiFePO₄ electrodes rapidly degrade when performing Li-storage and release reactions in the presence of phosphate or hydroxide ions. Li₃V₂(PO₄)₃ electrodes show chemical instability both in acidic and basic aqueous solutions. Thus, for the cells and methods described herein, only Li-storage electrodes that are chemically and electrochemically stable both in the Li-extraction cell and Li-recovery cell can be used.

Examples of Li-storage electrode materials suitable for one or more embodiments of the lithium extraction and recovery methods and systems described herein include, but are not limited to, LiTi₂(PO₄)₃, TiP₂O₇, 5,7,12,14 pentacenetetrone, and polyimides.

Any phosphate storage electrode material that is stable in the leachate solution can be used. Examples of suitable phosphate-storage electrode materials include bismuth (Bi), zinc (Zn), copper (Cu), and iron (Fe). However, Bi has the advantage of being the most stable in acidic media; Bi is stable in concentrated H₃PO₄ solutions with pH values as low as 0.25. The phosphate-storage electrode may contain these metals in their elemental form or in the form of compounds containing these metals, such as metal oxides, that are reduced to the elemental form of these metals during the operation of the electrochemical cell. During the electrochemical phosphate removal step (FIG. 1B), a voltage is applied across the anode and the cathode and the metal (e.g., Bi, Zn, Cu, or Fe) of the phosphate-storage electrode is oxidized to form one or more metal phosphates, resulting in the removal of phosphate from the electrolyte solution. By way of illustration, the phosphate-storage reaction that takes place using a bismuth-containing electrode is as follows:

Bi+H₂PO₄⁻→BiPO₄+2H⁺+3e⁻ (Eq. 4)

Analogous phosphate-storage reactions can be carried out using the other metals. (More details regarding the use of bismuth as a phosphate-storage electrode can be found in Nam, Do-Hwan and Choi, Kyoung-Shin. ACS Energy Letters 8.1 (2023): 802-808.)

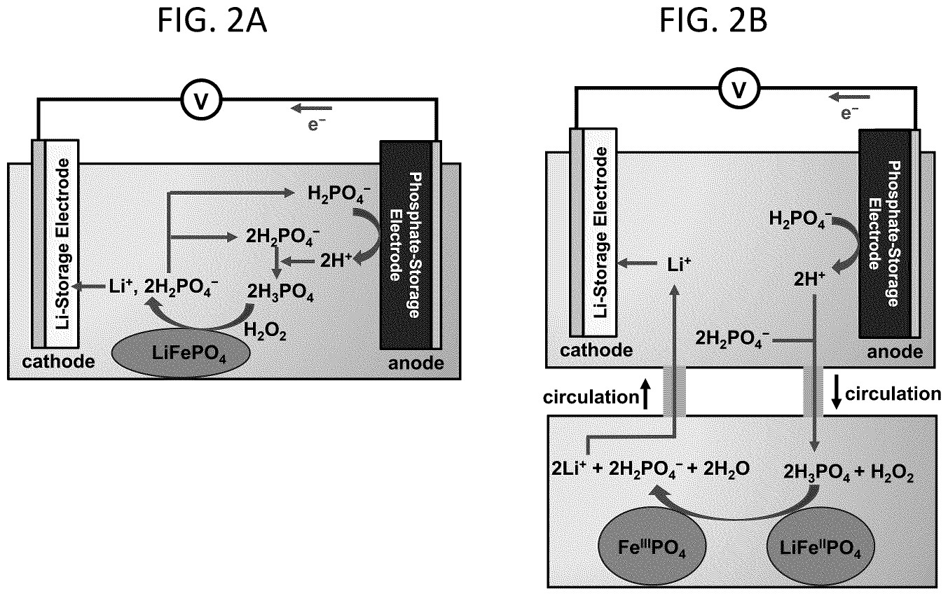

It is noteworthy that the reaction at the phosphate-storage anode decreases the pH of the solution by releasing H⁺ which reacts with H₂PO₄⁻ in the solution to regenerate phosphoric acid. This process is illustrated in FIG. 2A and described in more detail in the Example, below, which uses Bi as an illustrative phosphate-storage electrode. The regeneration of the acid, which was consumed for lithium leaching, during lithium extraction eliminates or reduces the amount of acid needed for further lithium leaching and is another unique advantage over hydrometallurgical methods.

For best results, it may be desirable to maintain the pH of the electrolyte solution in the range from 3 to 5. Below pH 3, some Li-storage electrodes do not operate optimally and above pH 5, the solubility of Lit starts to decrease due to the formation of Li₃PO₄(s). Therefore, when the production of H⁺ decreases the pH below 3, more LiFePO₄ and H₂O₂ (or other oxidant) can be added to the electrolyte solution in the cell to consume H⁺ by continuous Li leaching from LiFePO₄ and maintain the solution pH in the range from 3 to 5 (FIG. 2A). Alternatively, LiFePO₄ and H₂O₂ can be added to a separate tank (e.g., any container) that is connected to and in fluid communication with the electrochemical Li-extraction cell via conduits, such that the electrolyte solution can be circulated from the electrochemical cell, into the tank, and back into the electrochemical cell using pumps, valves, and flow-controllers (FIG. 2B). This design may be implemented to achieve better regulation of the pH and Lit concentration in the Li-extraction cell by controlling circulation of electrolytes between the Li-extraction cell and the LiFePO₄-containing tank.

It should be noted that the pairing of a lithium-storage electrode with a bismuth-containing electrode in an electrochemical cell is a novel pairing, and that the bismuth-containing electrode can be used to carry out electrochemical reactions other than phosphate-extraction and release. For example, bismuth can also be used as a chloride-storage electrode material or to carry out electrochemical oxygen evolution. Therefore, while the use of the bismuth-containing counter electrode as a phosphate-storage electrode is a focus of this disclosure, counter electrodes comprising bismuth can be used to carry out other reactions, such as chloride ion extraction and recovery.

### Electrochemical Recovery of Li⁺ and Phosphate as Li₃PO₄

The Li⁺ stored in the Li-storage electrode can be recovered in a subsequent electrochemical recovery step. Li recovery from the Li-storage electrode may be, but need not be, coupled with the recovery of phosphates from the phosphate-storage electrodes, whereby the lithium is recovered in the form of lithium phosphate (Li₃PO₄(s)), as shown in FIG. 1C. In this process, the Li-storage electrode and phosphate-storage electrode are placed in contact with a new electrolyte solution (a “Li-recovery solution”) by transferring the electrodes to a Li-recovery cell or by replacing the electrolyte solution in the Li-extraction cell with the new solution, thereby converting the Li-extraction cell into a Li-recovery cell. As such, the Li-recovery cell includes the (now lithiated) lithium-storage electrode and the (now phosphatated) phosphate-storage electrode connected by an external circuit or wire and a voltage source configured to apply a voltage across the electrodes. During Li recovery, the voltage across the electrodes is reversed with respect to the voltage applied during Li extraction, the Li-storage electrode serves as the anode, and the phosphate-storage electrode serves as the cathode.

By way of illustration, the phosphate-release reaction carried out at a phosphatated Bi (i.e., BiPO₄) electrode is as follows:

BiPO₄+3e⁻→Bi+PO₄³⁻ (Eq. 5)

The pH of the Li-recovery solution is adjusted so that the released lithium and phosphate ions can precipitates out as Li₃PO₄. The optimal pH of the solution may vary depending on the operating condition. The resulting high-purity Li₃PO₄ can be collected for various uses, including the synthesis of new LiFePO₄ electrodes. The electrolyte will contain a salt, such as LiCl (Li⁺ and Cl⁻ ions) as the supporting electrolyte to ensure the solution conductivity of the recovery cell. This salt is not consumed and does not affect the purity of Li₃PO₄ generated in this Li-recovery cell, as LiCl is highly soluble regardless of pH.

### Electrochemical Recovery of Li as LiOH or Li₂CO₃ and Phosphate as H₃PO₄

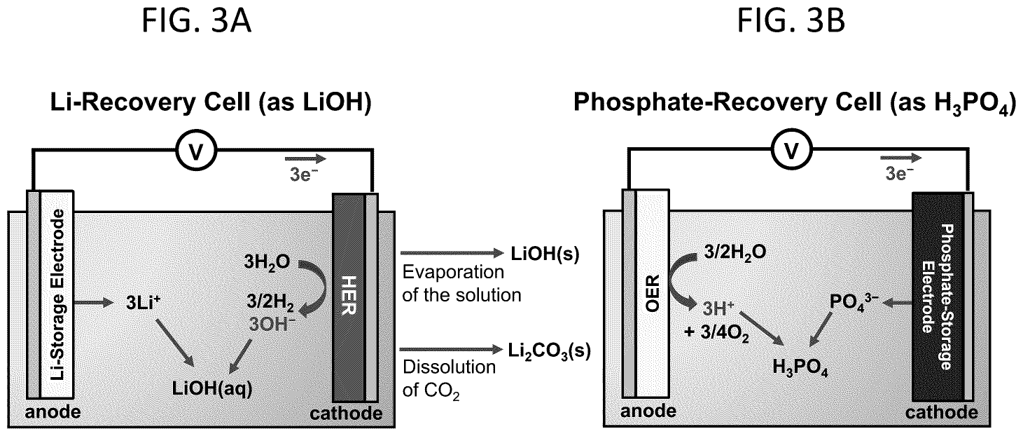

The release of lithium ions from the Li-storage electrode in the Li-recovery cell need not be paired with the release of phosphate ions and the formation of lithium phosphate. In some embodiments of the electrochemical methods and systems described herein, the release of lithium ions in the lithium-recovery cell is paired with a hydrogen evolution reaction (HER) at the cathode in a dilute lithium hydroxide solution, which is to ensure the solution conductivity without affecting the purity of the final Li-containing product, as illustrated in FIG. 3A. In these embodiments, the cathode may contain a hydrogen evolution catalyst, such as platinum, nickel, molybdenum, cobalt, and their alloys and compounds (e.g., phosphides and sulfides), and performs water reduction in an aqueous electrolyte solution to form H₂ and hydroxide (OH^{-) ions:}

(HER): 2H₂O+2e⁻→H₂+2OH³¹ (Eq. 6)

The hydroxide ions generated from the HER and Li⁺ released from the Li-storage electrode during the operation of the Li-recovery cell are accumulated as LiOH_{(aq)} in the aqueous electrolyte solution. The use of HER as the cathode reaction has the advantage of not requiring the addition of any other chemicals/reactants to the aqueous electrolyte solution, as water is the reactant, while also generating H₂, which can be collected and utilized as a clean fuel.

In other embodiments of the electrochemical methods and systems described herein, the release of lithium ions in the lithium-recovery cell is paired with an oxygen reduction reaction (ORR) in a dilute lithium hydroxide solution to form OH⁻ ions according to the reaction:

(ORR): O₂+2H₂O+4e⁻→4OH⁻ (Eq. 7)

The hydroxide ions react in solution with the released lithium ions and, as a result, during the operation of the Li-recovery cell, Li⁻ is accumulated as LiOH_{(aq)} in the aqueous electrolyte solution. The use of ORR as the cathode reaction has the advantage of decreasing the electrical energy input needed to operate the Li-recovery cell, as the standard reduction potential of ORR (1.23 V vs. SHE) is more positive than that of HER (0.00 V vs. SHE) by more than 1 V. In fact, as the ORR potential is more positive than that of the delithiation potential of many Li-storage electrodes, depending on the Li-storage electrode selected, the delithiation reaction coupled with ORR can occur spontaneously, meaning the Li-release reaction in the presence of O₂ in the solution may take place without needing any electrical energy input, making the overall Li-recovery process more energy efficient. For some Li storage electrodes, even the delithiation reaction coupled with HER can also occur spontaneously, depending on the pH of the electrolyte used in the Li-recovery cell.

Once the desired concentration of LiOH_{(aq)} is reached, water can be evaporated from the electrolyte solution to collect the LiOH₍ₛ₎. The volume of the electrolyte used in the Li-recovery cell does not need to be the same as that used in the Li-extraction cell and it can be minimized to reduce the amount of water that needs to be evaporated to collect LiOH₍ₛ₎.

As an alternative to the recovery of lithium in the form of LiOH₍ₛ₎, the Li-recovery cell of FIG. 3A can be used to collect the lithium in the form of lithium carbonate (Li₂CO₃₍ₛ₎). This can be accomplished by dissolving CO_{2(g)} in the alkaline LiOH_{(aq)} solution generated in the Li-recovery cell, whereby the CO_{2(g)} is converted into HCO₃^{- or CO}₃²⁻ (Eqs. 8 and 9), which reacts with the Li⁺ released from the lithium-storage electrode by the anode reaction to form LiHCO_{3(aq)} and/or Li₂CO₃₍ₛ₎ (Eqs. 10 and 11). The LiHCO₃ and/or Li₂CO₃ can also be produced using a soluble bicarbonate or carbonate chemical, such as Na₂CO₃, as a reactant instead of, or in addition to, CO_{2(g)}.

OH⁻+CO₂→HCO₃⁻ (Eq. 8)

2OH⁻+CO₂→CO₃²⁻+H₂O (Eq. 9)

Li⁺+HCO₃⁻→LiHCO₃ (Eq. 10)

2Li⁺+CO₃²⁻→Li₂CO₃ (Eq. 11)

Notably, when Li is recovered as LiOH, OH⁻ is produced from water reduction. When Li⁺ is recovered as LiHCO₃ or Li₂CO₃, HCO₃⁻ and CO₃²⁻ are produced by the capture of CO₂ using OH⁻ generated from water oxidation. Thus, for all cases, no additional chemicals other than water and CO₂ are needed to generate Li-containing chemicals. The recovery of Li⁻ as LiHCO₃ or Li₂CO₃ using CO₂ capture can also contribute to carbon negative economy as CO₂ is captured and used to make useful chemicals.

When phosphate extraction is coupled with Li-extraction, but phosphate recovery is not coupled with Li-recovery, the phosphate may be recovered from the phosphatated phosphate-storage electrode in a separate phosphate-recovery cell. Some embodiments of the phosphate recovery cell couple the phosphate-storage electrode with an oxygen evolution anode, as shown schematically in FIG. 3B. In these embodiments, the anode may contain an oxygen evolution catalyst and performs water oxidation via an oxygen evolution reaction (OER) in an aqueous electrolyte solution to form H⁺ and O₂, as shown below.

(OER): H₂O→1/2O ₂+2H⁺+2e⁻ (Eq. 12)

The H⁺ reacts with phosphate ions released from the phosphate-storage electrode by the cathode reaction to produce phosphoric acid. Any inert electrode that can perform OER may be used. Suitable oxygen evolution catalysts include Pt, noble metal oxides (e.g., RuOₓ or IrOₓ), or nonnoble metal oxides that are stable in acid (e.g., Bi-based or Sb-based oxides).

### Electrochemical Extraction Using H₂SO₄ With Recovery of Li as LiOH or Li₂CO₃

In some embodiments of the present methods and systems, electrochemical Li extraction is not coupled with phosphate ion extraction. In these embodiments, the acid in the electrolyte solution need not be phosphoric acid, and a variety of anodes may be used in place of the phosphate-storage electrode in FIG. 1B. In some embodiments of the Li-extraction cell, sulfuric acid is used as the leachant acid, and the Li⁺-leaching reaction is shown in Eq. 3.

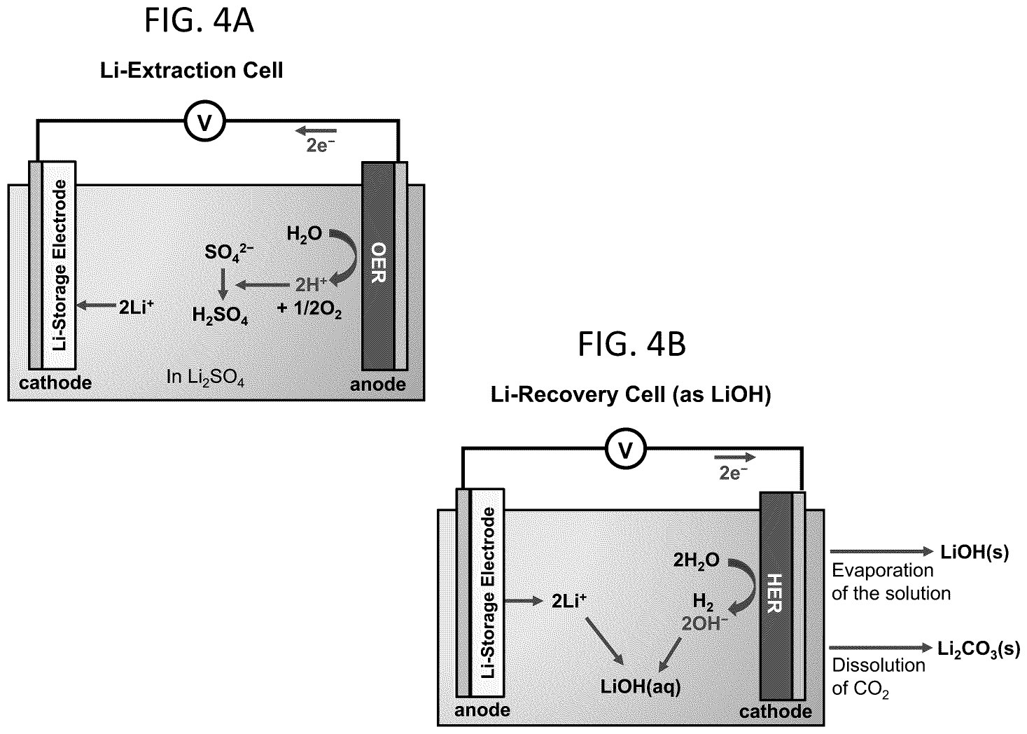

In Li-extraction cells that include sulfuric acid in the electrolyte, the electrochemical lithium extraction may be coupled with OER at the anode, as shown in the Li-extraction cell of FIG. 4A. Any electrode that can perform OER may be used.

Because phosphate ions are not present in the electrolyte solution in these embodiments, Li-storage electrodes that are not stable in the presence of phosphate can now be used for the lithium extraction.

The lithiated electrode of FIG. 4A can then be paired with a variety of cathodes in a Li-recovery cell. In some embodiments of the methods and systems, the release of lithium ions in the Li-recovery cell is paired with HER at the cathode in a dilute lithium hydroxide solution, as illustrated in FIG. 4B, and the lithium can be recovered as LiOH, LiHCO₃, and/or Li₂CO₃ by the processes described above for the Li-recovery cell of FIG. 3A. As the anode reaction in the Li-extraction cell in this case does not require the presence of phosphate and instead uses water as the reactant for OER, this Li-extraction cell can be used for extracting Li from various other Li-containing aqueous solutions that may not contain phosphate, which include Li-leaching solutions from LIB electrodes other than LiFePO₄ (e.g., lithium cobalt oxides, lithium nickel manganese oxides, lithium nickel cobalt manganese oxides, lithium nickel cobalt aluminum oxides), Li-containing brines, and Li-containing wastewater produced from Li-ore processing, manufacturing of LIBs, or various other Li recovery processes carried out on spent LIB electrodes.

### Chemical Waste Reduction

Again, it is worth noting that a universal feature of the present electrochemical lithium extraction and recovery methods is that the acid used in the leachate/electrolyte solution that is consumed during the lithium leaching is entirely regenerated by the counter electrode reactions in the Li-extraction and/or phosphate-recovery cells using water as the proton source, which minimizes the use of acids required for Li leaching. Moreover, the anions needed to convert extracted Li to Li-containing chemicals (e.g., phosphate, hydroxide, and carbonate) can be obtained from the acid used for Li leaching (i.e., phosphate) or are generated by the counter electrode reactions in situ using water (i.e., hydroxide) and CO₂ (i.e., carbonate). This minimizes the use of acids, bases, and other chemicals, thereby also reducing the amount of waste produced from the Li recovery process.

### EXAMPLE

This example demonstrates methods for the electrochemical extraction and recovery of lithium from LiFePO_{4.}

### Li Leaching From LiFePO₄

For this example, leaching was carried out using phosphoric acid as follows. Quantities of 0.5 M LiFePO₄ and 1.0 M H₂O₂ were added to 0.5 M H₃PO₄ solution. The Li⁺-leaching reaction consumed a stoichiometric amount of H⁺ as shown in Eq. 1 (Li⁺:H⁺=1:1), thus increasing the solution pH. For example, the initial pH of 0.5 M H₃PO₄ solution was around 1 and the final pH after Li⁺ leached out from 0.5 M LiFePO₄ was between 3 and 4. The H₃PO₄ served as the proton source.

The Li and Fe ion concentrations in the leachate solution after Li⁺ leaching were examined by inductively coupled plasma mass spectrometry (ICP-MS). The results show that the example conditions effectively leached Li⁺ from LiFePO₄; ˜80% Li⁺ leaching from 0.5 M LiFePO₄ could be completed in 30 min at room temperature with no detectable Fe. When desired, the leaching rate can be expedited by changing the leaching conditions.

### Electrochemical Lithium and Phosphate Extraction From the Leachate Solution

In the Li-extraction cell (FIG. 1B), a Li-storage electrode is used as the cathode and a phosphate-storage electrode is used as the anode. For this example, LiTi₂ (PO₄)₃ was used as an illustrative Li-storage electrode and Bi was used as an illustrative phosphate-storage electrode.

For this cell, when an appropriate voltage is applied between the cathode and anode, the cathode stores Li⁺ and the anode stores PO₄³⁻ as described below.

Cathode: 3LiTi₂(PO₄)₃+6Li⁺+6e⁻→3Li₃Ti₂(PO₄)₃ (Eq. 13)

Anode: 2Bi+2H₂PO₄⁻→2BiPO₄+4H⁺+6e⁻ (Eq. 14)

Net: 2Bi+2H₂PO₄⁻+3Li₃Ti₂(PO₄)₃+6Li⁺→2BiPO₄+4H⁺+3LiTi₂(PO₄)₃ (Eq. 15)

The pH of this solution was maintained to be between 3 and 5. While the cathode reaction (Eq. 13) did not affect the solution pH, the anode reaction (Eq. 14) decreased the pH. The dominant phosphate species at pH=3-5 is H₂PO₄⁻. When the anode reaction stored H₂PO₄ as PO₄³⁻ converting Bi to BiPO₄ (Eq. 14), 2H⁺ was released from H₂PO₄⁻, decreasing the solution pH and converting H₂PO₄⁻ to H₃PO₄ (Eq. 16).

4H₂PO₄⁻+4H⁺→4H₃PO₄ (Eq. 16)

In Eqs. 1-2, it is shown that leaching of Li⁺ consumes H⁺ (Li⁺:H⁺=1:1) converting an equimolar H₃PO₄ to H₂PO₄⁻. In Eq. 13 and 14, it is shown that the ratio of Li⁺ stored at the cathode and H⁺ generated at the anode is 3:2, and H⁺ generated is used to convert H₂PO₄⁻ to H₃PO₄. This means out of 0.5 M H₃PO₄ consumed to leach 0.5 M Li⁺ from LiFePO₄ in the leachate solution, 67% H₃PO₄ was regenerated in the Li-extraction cell by the anode electrode reaction when 0.5 M Li⁺ was stored at the cathode. This means that only 33% of the stoichiometric amount of H₃PO₄ was consumed for Li⁺ leaching in net.

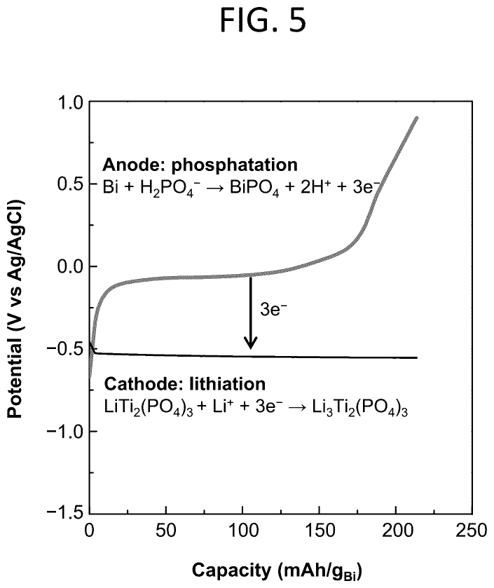

FIG. 5 shows typical potential-capacity (V-t) plots of the anode and cathode vs. the Ag/AgCl (4 M KCl) reference electrode during the operation of the Li-extraction cell at a constant current density of 7.68 mA/cm² (equivalent to a 1.9 C rate for the Bi electrode whose theoretical capacity is 384 mA h/g). The electrolyte solution was 0.5 M LiH₂PO₄, which models the leachate solution obtained from dissolving 0.5 M LiFePO₄ in 0.5 M H₃PO₄ (Eq. 2). The potential difference between the anode and cathode is the voltage needed to operate the Li-extraction cell. FIG. 5 shows that the average voltage needed to operate the Li-extraction cell at 7.68 mA/cm² is 0.61 V.

The Faradic efficiencies for the Li-storage reaction by the LiTi₂(PO₄)₃ electrode and for the phosphate-storage reaction by the Bi electrode were examined by comparing the charge passed during the operation of the Li-extraction cell and the actual changes in the lithium and phosphate concentrations of the electrolyte solution, which were determined by ICP-MS. The Faradic efficiencies were calculated to be ˜70% for the Li-storage reaction and >95% for the phosphate-storage reaction. The Faradic efficiency for the Li-storage reaction can be improved by optimizing electrode fabrication and operating conditions.

### Electrochemical Recovery of Li⁺ and Phosphate as Li₃PO₄

The saturated Li-storage electrode and phosphate-storage electrode were transferred to the Li-recovery cell where these electrodes released Li⁺ and phosphate, respectively (FIG. 1C). In this cell, the Li-storage electrode served as the anode and the phosphate-storage electrode served as the cathode. When Li⁺ and phosphate were released into a solution exceeding their solubility limit (Kₛₚ of Li₃PO₄ is 3.2×10⁻⁹), they co-precipitated as Li₃PO₄, in accordance with the reactions below.

Anode: 3Li₃Ti₂(PO₄)₃→3LiTi₂(PO₄)₃+6Li⁺+6e⁻ (Eq. 17)

Cathode: 2BiPO₄+6e⁻→2Bi+2PO₄³⁻ (Eq. 18)

Net: 2BiPO₄+3Li₃Ti₂(PO₄)₃→2Bi+3LiTi₂(PO₄)₃+2Li₃PO₄ (Eq. 19)

In this example, the electrolyte solution used in the recovery cell was 0.5 M LiCl.

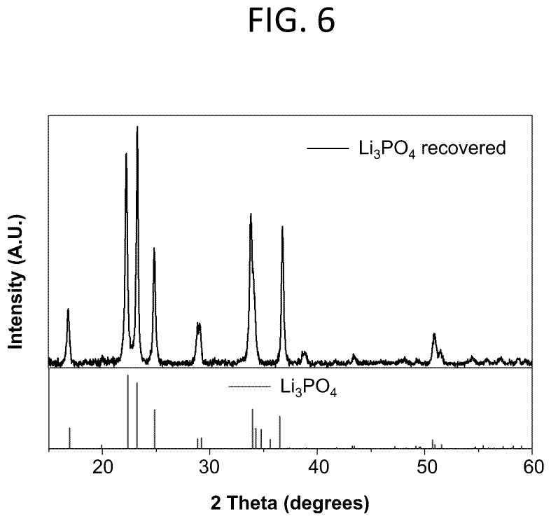

The white power precipitated in the Li-recovery cell was confirmed to be pure Li₃PO₄ by X-ray diffraction (FIG. 6), which also confirmed that Cl⁻ in this solution did not affect the purity of the Li₃PO₄ formed.

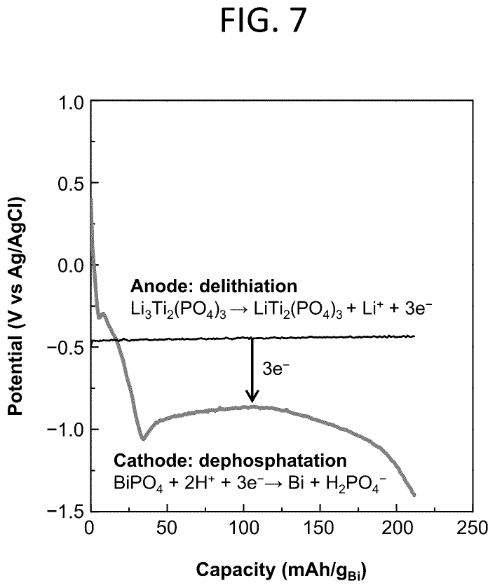

The typical V-t profiles of the anode and cathode vs. the Ag/AgCl (4 M KCl) reference electrode during the Li-recovery cell operation at a constant current density of 7.68 mA/cm² in 0.5 M LiCl are shown in FIG. 7. The potential difference between the anode and cathode is the voltage needed to operate the Li-recovery cell. FIG. 7 shows that the average voltage needed to operate the Li-recovery cell at 7.68 mA/cm² is 0.45 V.

The Faradic efficiencies for Li recovery and phosphate recovery reactions were calculated by comparing the charges passed during the operation of the Li-recovery cell and the amounts of Li⁺ and phosphate recovered in the Li-recovery cell, which were quantified using ICP-MS. To increase the accuracy for Li quantification, 0.5 M NaCl instead of 0.5 M LiCl was used to prepare samples for the ICP-MS measurements. The Faradic efficiencies were calculated to be >95% for both the Li⁺ recovery and phosphate recovery reactions.

### Cycle Performances of Electrodes

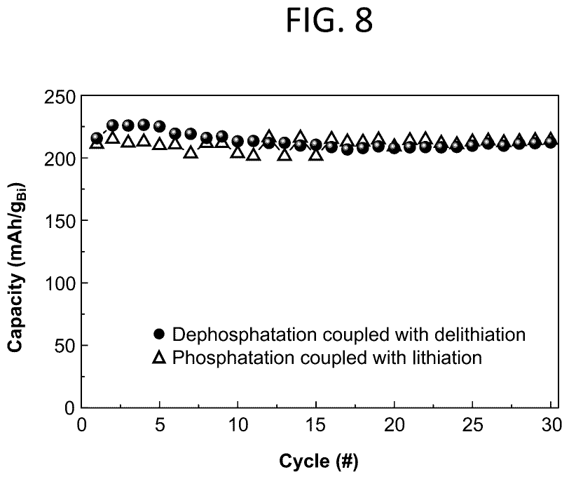

The cycle performance of the Bi electrode for phosphatation and dephosphatation that was coupled with the cycle performance of the LiTi₂(PO₄)₃ electrode for lithiation and delithiation is shown in FIG. 8. For this cycle test, the lithiation and phosphatation reactions were performed in 0.5 M LiH₂PO₄, and the delithiation and dephosphatation reactions were performed in 0.5 M LiCl. The results show no capacity fading.

### Electrochemical Recovery of Li as LiOH or Li₂CO₃ and phosphate as H₃PO₄ (Prophetic)

The above results show that the extracted Li⁺ and phosphate can be recovered as Li₃PO₄. However, it is possible to split the Li-recovery cell into two cells so that Li⁺ is recovered as LiOH (FIG. 3A) and phosphate is recovered as H₃PO₄ (FIG. 3B), as discussed above.

In the Li-recovery cell, the Li-release reaction by the Li-storage reaction (anode) can be paired with a hydrogen evolution reaction (HER) or the oxygen reduction reaction (ORR) by the cathode in a dilute LiOH solution. HER and ORR both produce OH⁻:

Anode: 3Li₃Ti₂(PO₄)₃→3LiTi₂(PO₄)₃+6Li⁺+6e⁻ (Eq. 17)

Cathode (HER): 6H₂O+6e⁻→3H₂+6OH⁻ (Eq. 20)

Cathode (ORR): 3/2O₂+3H₂O+6e⁻→6OH⁻ (Eq. 21)

Thus, during the cell operation Li⁺ is accumulated as LiOH in the solution. The lithium can also be recovered as Li₂CO₃, as discussed above.

In the phosphate-recovery cell (FIG. 3B), the phosphate-storage electrode saturated with phosphate (BiPO₄) serves as the cathode and performs a phosphate-release reaction paired with the anode that performs the oxygen evolution reaction (OER). (Nam, Do-Hwan and Choi, Kyoung-Shin. ACS Energy Letters 8.1 (2023): 802-808.)

Cathode: 2BiPO₄+6e⁻→2Bi+2PO₄³⁻ (Eq. 18)

Anode: 3H₂O→3/2O₂+6H⁺+6e⁻ (Eq. 22)

Net: 2BiPO₄+3H₂O→2Bi+2H₃PO₄ (Eq. 23)

The phosphate released from the cathode and H⁺ generated from the anode combine to form H₃PO₄ (Eq. 23). The amount of phosphate generated in this cell is equivalent to ⅓ of H₃PO₄ consumed to leach Lit from LiFePO₄ (Eq. 2). As 67% H₃PO₄ is regenerated at the anode in the Li-extraction cell and 33% H₃PO₄ is regenerated at the cathode in the phosphoric acid recovery cell, theoretically 100% H₃PO₄ used for Li-leaching is recovered when Li is recovered as LiOH or Li₂CO₃. This is possible because when Li is recovered as LiOH or Li₂CO₃, phosphate is not used in the final form of Li-containing chemicals (i.e., Li₃PO₄) and H⁺ is additionally generated in the phosphoric acid recovery cell. In contrast, when Li is recovered as Li₃PO₄, 67% H₃PO₄ is regenerated in the Li-extraction cell and none is recovered in the Li-recovery cell, as the remaining 33% of phosphate is consumed to recover Li⁺ as Li₃PO_{4.}

The fact that the anionic part of Li-containing chemicals is obtained either from the acid used for Li leaching (i.e., H₃PO₄) or from H₂O and CO₂ makes this method greener and more sustainable than other approaches.

### Using Different Acids for Li Leaching (Prophetic)

Sulfuric acid can be used in the leachate solution (Eq. 3), rather than phosphoric acid to carry out the following electrode reactions:

Cathode: LiTi₂(PO₄)₃ +2Li⁺+2e⁻→Li₃Ti₂(PO₄)₃ (Eq. 24)

Anode (OER): H₂O→1/2O₂+2H⁺+2e⁻ (Eq. 5)

The H⁺ generated at the anode in the Li-extraction cell decreases the pH (Eq. 5) and regenerates the H₂SO₄ (Eq. 25) consumed during the Li-leaching process (Eq. 3). Thus, theoretically, this process in net does not consume acid, enabling continuous and sustainable Li⁺ leaching from LiFePO₄ (FIG. 4A).

SO₄²⁻+2H⁺→H₂SO₄ (Eq. 25)

As described above, the recovery of Li in the Li-recovery cell can be performed by coupling the Li-release reaction with HER or ORR, which recovers Li as LiOH or Li₂CO₃ (FIG. 4B).

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents. WHAT IS CLAIMED IS:
1 A method for electrochemically extracting and recovering lithium ions from lithium iron phosphate, the method comprising:
leaching lithium ions from lithium iron phosphate into an aqueous leachate solution;
contacting the aqueous leachate solution with a lithium-storage electrode and carrying out an electrochemical lithium ion extraction from the aqueous leachate solution using the lithium-storage electrode, whereby the lithium-storage electrode becomes lithiated; and
contacting the lithiated lithium-storage electrode with an aqueous lithium-recovery solution, wherein the lithium-recovery solution is not the same solution as the aqueous leachate solution, and carrying out an electrochemical delithiation of the lithiated lithium-storage electrode, whereby lithium ions from the lithiated lithium-storage electrode are released into the aqueous lithium-recovery solution.

2. The method of claim 1, wherein the aqueous leachate solution further comprises phosphate ions and the aqueous leachate solution is contacted with the lithium-storage electrode and a phosphate-storage electrode, the method further comprising: carrying out an electrochemical phosphate ion extraction from the aqueous leachate solution using the phosphate-storage electrode, whereby the phosphate-storage electrode becomes phosphatated.

3. The method of claim 2, further comprising contacting the phosphatated phosphate-storage electrode with the aqueous lithium-recovery solution and carrying out an electrochemical dephosphatation of the phosphatated phosphate-storage electrode, whereby phosphate ions are released into the aqueous lithium-recovery solution, and lithium phosphate is accumulated in the lithium-recovery solution.

4. The method of claim 2, wherein the phosphate-storage electrode comprises bismuth.

5. The method of claim 1, further comprising carrying out an electrochemical hydrogen evolution reaction simultaneously with the electrochemical delithiation of the lithiated lithium-storage electrode, whereby water molecules in the aqueous lithium-recovery solution are reduced and hydroxide ions are produced, and lithium hydroxide is accumulated in the lithium-recovery solution.

6. The method of claim 5, further comprising introducing carbon dioxide, a bicarbonate salt, or a carbonate salt into the aqueous lithium-recovery solution to recover lithium as LiHCO₃ or Li₂CO₃ from the lithium-recovery solution.

7. The method of claim 1, further comprising carrying out an electrochemical oxygen reduction reaction simultaneously with the electrochemical delithiation of the lithiated lithium-storage electrode, whereby oxygen molecules present in the aqueous lithium-recovery solution are reduced and hydroxide ions are produced, and lithium hydroxide is accumulated in the lithium-recovery solution.

8. The method of claim 7, further comprising introducing carbon dioxide, a bicarbonate salt, or a carbonate salt into the lithium-recovery solution to recover lithium as LiHCO₃ or Li₂CO₃ from the lithium-recovery solution.

9. The method of claim 1, further comprising carrying out an electrochemical oxygen evolution reaction simultaneously with the electrochemical lithium ion extraction, whereby water molecules in the aqueous leachate solution are oxidized to form protons in the aqueous leachate solution.

10. The method of claim 9, wherein the aqueous leachate solution further comprises sulfate ions.

11. The method of claim 1, wherein the lithium-storage electrode comprises LiTi₂(PO₄)₃.

12. The method of claim 1, wherein the lithium-storage electrode comprises TiP₂O₇.

13. The method of claim 1, wherein the lithium-storage electrode comprises 5,7,12,14 pentacenetetrone.

14. The method of claim 1, wherein the lithium-storage electrode comprises polyimide.

15. A method for electrochemically extracting and recovering lithium ions from a lithium ion-containing aqueous solution, the method comprising:
contacting the lithium ion-containing aqueous solution with a lithium-storage electrode comprising LiTi₂(PO₄)₃, TiP₂O₇, 5,7,12,14 pentacenetetrone, or polyimide and a counter electrode;
carrying out an electrochemical lithium ion extraction from the lithium ion-containing aqueous solution using the lithium-storage electrode, whereby the lithium-storage electrode becomes lithiated;
carrying out an electrochemical oxidation in the lithium ion-containing aqueous solution simultaneously with the electrochemical lithium ion extraction; and
contacting the lithiated lithium-storage electrode with an aqueous lithium-recovery solution, wherein the aqueous lithium-recovery solution is not the same solution as the lithium ion-containing aqueous solution, and carrying out an electrochemical delithiation of the lithiated lithium-storage electrode, whereby lithium ions from the lithiated lithium-storage electrode are released into the aqueous lithium-recovery solution.

16. The method of claim 15, wherein the lithium-storage electrode comprises the LiTi₂(PO₄)₃.

17. The method of claim 15, wherein the lithium ion-containing aqueous solution further comprises phosphate ions and the lithium ion-containing aqueous solution is contacted with the lithium-storage electrode and a phosphate-storage electrode, the method further comprising carrying out an electrochemical phosphate ion extraction from the aqueous leachate solution using the phosphate-storage electrode, whereby the phosphate-storage electrode becomes phosphatated.

18. The method of claim 15, further comprising carrying out an electrochemical hydrogen evolution reaction simultaneously with the electrochemical delithiation of the lithiated lithium-storage electrode, whereby water molecules in the aqueous lithium-recovery solution are reduced and hydroxide ions are produced, and lithium hydroxide is accumulated in the lithium-recovery solution.

19. The method of claim 15, further comprising carrying out an electrochemical oxygen reduction reaction simultaneously with the electrochemical delithiation of the lithiated lithium-storage electrode, whereby oxygen molecules present in the aqueous lithium-recovery solution are reduced to form hydroxide ions and lithium hydroxide is accumulated in the lithium-recovery solution.

20. An electrochemical cell comprising:
a lithium-storage electrode;
a counter electrode that is either:
a phosphate-storage electrode comprising bismuth or another phosphate-storage material; or
a chloride-storage electrode comprising bismuth or an oxygen evolution electrode comprising bismuth; and
an external circuit or wire connecting the lithium-storage electrode to the counter electrode.
